(19) United States
(12) Patent Application Publication
(10) Pub. No.: US 2015/0161592 A1
(43) Pub. Date: Jun. 11, 2015

(54) METHOD FOR PAYMENT USING MEMBERSHIP CARD AND ELECTRONIC DEVICE THEREOF

(71) Applicant: Samsung Electronics Co., Ltd., Gyeonggi-do (KR)

(72) Inventors: Chol-Seo PARK, Seoul (KR); Kyung-Dong KIM, Gyeonggi-do (KR); Shin-Woo LEE, Seoul (KR)

(21) Appl. No.: 14/558,841

(22) Filed: Dec. 3, 2014

(30) Foreign Application Priority Data
Dec. 5, 2013 (KR) 10-2013-0150577

(51) Int. Cl. G06Q 20/34; G06Q 20/22; G06Q 20/38; G06Q 20/40

(52) U.S. Cl. CPC G06Q 20/341; G06Q 20/40; G06Q 20/227; G06Q 20/387

(57) ABSTRACT

An electronic device and method for payment using a membership card are provided. In a method of operating an electronic device in which a membership number is stored, the method includes displaying by a display a plurality of payment cards, detecting by a controller selection of at least one of the plurality of payment cards, and transmitting to a payment server a membership number and a card identifier identifying the selected at least one of the plurality of payment cards, wherein the payment server approves a payment to the selected at least one of the plurality of payment cards when the membership number matches a second membership identifier received from a membership card that was swiped at a payment terminal.

### CLAIM OF PRIORITY

This application claims the benefit under 35 U.S.C. §119(a) of a Korean patent application filed in the Korean Intellectual Property Office on Dec. 5, 2013 and assigned Serial No. 10-2013-0150577, the entire disclosure of which is hereby incorporated by reference.

### TECHNICAL FIELD

The present disclosure relates generally to a method for payment using a membership card and an electronic device thereof.

### BACKGROUND

With the advancement of information communication techniques and semiconductor techniques, various electronic devices are under development into multimedia devices for providing various multimedia services. For example, the electronic device may provide a multimedia service such as a voice telephony service, a video telephony service, a messenger service, a broadcast service, a wireless Internet service, a camera service, and a music play service.

### SUMMARY

An aspect of the present disclosure is to provide an apparatus and method in which a membership card is used for payment, and thereafter a payment price is approved by selecting a payment card issued for an electronic device to complete the payment, so that the payment is achieved with one membership card without having to carry a plurality of payment cards, thereby being able to improve a user convenience.

Another aspect of the present disclosure is to provide a method in an electronic device, the method comprising displaying by a display a plurality of payment cards, detecting by a controller selection of at least one of the plurality of payment cards, and transmitting to a payment server a membership number and a card identifier identifying the selected at least one of the plurality of payment cards, wherein the payment server approves a payment to the selected at least one of the plurality of payment cards when the membership number matches a second membership identifier received from a membership card that was swiped at a payment terminal.

Another aspect of the present disclosure is to provide a method in a payment server, the method comprising receiving from a payment terminal a first request to process a payment including a membership number, in response to the request, executing a payment standby state, and transmitting to a terminal server specific information including the membership number, and a first request identification to identify the payment, receiving from the terminal server a second request to process the payment and a card identifier and a second request identification, wherein the terminal server: identifies a portable terminal based on the membership number, receives the card identifier from the portable terminal identifying a payment card to be used for the payment from the portable terminal, and receives a second request identification from the portable terminal generated from the first request identification, and transmitting to the card terminal an approval of the payment when the first request identification matches the second request identification.

Another aspect of the present disclosure is to provide a method in a terminal server, the method comprising receiving from a payment server specific information including a membership number of a membership card swiped at payment terminal and transmitted to the payment server, detecting an electronic device communicatively coupled to the terminal server corresponding to the membership number, and receiving from the detected electronic device a card identifier corresponding to a payment card, and transmitting to the payment server a request to process a payment utilizing the payment card indicated by the card identifier.

Another aspect of the present disclosure is to provide an electronic device comprising: a display module, a communication module, and a processor configured to displaying by the display module a plurality of payment cards, detecting a selection of at least one of the plurality of payment cards, and transmitting to a payment server a membership number and a card identifier identifying the selected at least one of the plurality of payment cards, wherein the payment server approves a payment to the selected at least one of the plurality of payment cards when the membership number matches a second membership identifier received from a membership card that was swiped at a payment terminal.

Another aspect of the present disclosure is to provide a payment server apparatus comprising: a communication unit; and a control unit configured to receive from a payment terminal a first request to process a payment including a membership number, in response to the request, execute a payment standby state and transmitting to a terminal server specific information including the membership number, and a first request identification to identify the payment, receive from the terminal server a second request to process the payment and a card identifier and a second request identification, wherein the terminal server: identifies a portable terminal based on the membership number, receives the card identifier from the portable terminal identifying a payment card to be used for the payment from the portable terminal, and receives a second request identification from the portable terminal generated from the first request identification, and transmits to the card terminal an approval of the payment when the first request identification matches the second request identification.

Another aspect of the present disclosure is to provide a terminal server apparatus comprising: a communication unit, and a control unit configured to receive from a payment server specific information including a membership number of a membership card swiped at payment terminal and transmitted to the payment server, detect an electronic device communicatively coupled to the terminal server corresponding to the membership number; and receive from the detected electronic device a card identifier corresponding to a payment card, an transmit to the payment server a request to process a payment utilizing the payment card indicated by the card identifier.

### BRIEF DESCRIPTION OF THE DRAWINGS

Certain example embodiments of the present disclosure will be more apparent from the following detailed description taken in conjunction with the accompanying drawings, in which:

FIG. 1 is a block diagram of an example electronic device according to an example embodiment of the present disclosure;

FIG. 2 is a block diagram of an example hardware structure according to an example embodiment of the present disclosure;

FIG. 3 is a block diagram of an example programming module according to an example embodiment of the present disclosure;

FIG. 4 illustrates an example overall operation order when a membership card is used in payment according to a first example embodiment of the present disclosure;

FIG. 5 illustrates an example overall operation order when a membership card is used in payment according to an example embodiment of the present disclosure;

FIG. 6A, FIG. 6B, and FIG. 6C illustrate an example embodiment in which a payment card is selected by executing a payment application according to the present disclosure;

FIG. 7A, FIG. 7B, FIG. 7C, and FIG. 7D illustrate an example embodiment in which a payment card is selected by executing a payment application according to the present disclosure;

FIG. 8 is a flowchart illustrating an example operation order of an electronic device according to an example embodiment of the present disclosure;

FIG. 9 is a flowchart illustrating an example operation order of a server according to an example embodiment of the present disclosure;

FIG. 10 is a flowchart illustrating an example operation order of an electronic device according to an example embodiment of the present disclosure;

FIG. 11 is a flowchart illustrating an example operation order of a first server according to an example embodiment of the present disclosure;

FIG. 12 is a flowchart illustrating an example operation order of a second server according to an example embodiment of the present disclosure;

FIG. 13 is a flowchart illustrating an example method of an electronic device according to the present disclosure;

FIG. 14 is a flowchart illustrating an example method of a first server according to the present disclosure;

FIG. 15 is a flowchart illustrating an example method of a second server according to the present disclosure; and

FIG. 16 is a block diagram illustrating an example structure of a server according to the present disclosure.

### DETAILED DESCRIPTION

Hereinafter, the present disclosure is described with reference to the accompanying drawings. While the present disclosure is susceptible to various modifications and alternative forms, a specific embodiment thereof has been shown by way of example in the drawings and will herein be described in detail. It should be understood, however, that it is not intended to limit the present disclosure to the particular form disclosed, but, on the contrary, the present disclosure is to cover all modifications, equivalent, and alternatives falling within the ambit of the present disclosure as defined by the appended claims. Like reference numerals denote like elements throughout the drawings.

An electronic device according to the present disclosure may be a device including a communication function. For example, the electronic device may be one or more combinations of various devices such as a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), a MPEG-1 Audio Layer 3 (MP3) player, a mobile medical device, an electronic bracelet, an electronic necklace, an electronic appcessory, a camera, a wearable device, an electronic clock, a wrist watch, a smart white appliance (e.g., a refrigerator, an air conditioner, a cleaner, an artificial intelligent robot, a TeleVision (TV), a Digital Video Disk (DVD) player, an audio, an oven, a microwave oven, a washing machine, an air purifier, an electronic picture frame, etc.), various medical devices (e.g., Magnetic Resonance Angiography (MRA), Magnetic Resonance Imaging (MRI), Computed Tomography (CR), imaging equipment, ultrasonic instrument, etc.), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, a car infotainment device, an electronic equipment for ship (e.g., a vessel navigation device, a gyro compass, etc.), avionics, a security device, an electronic costume, an electronic key, a camcorder, game consoles, a Head-Mounted Display (HMD), a flat panel display device, an electronic album, a furniture or a part of building/constructions including a communication function, an electronic board, an electronic signature receiving device, a projector, and the like. It is apparent to those ordinarily skilled in the art that the electronic device according to the present disclosure is not limited to the aforementioned devices.

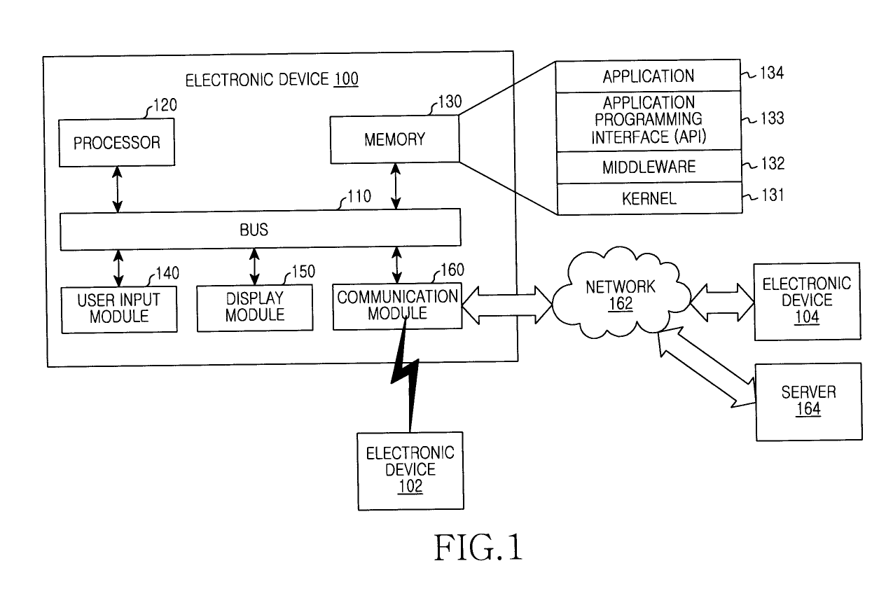

FIG. 1 is a block diagram of an electronic device according to an example embodiment of the present disclosure. Referring to FIG. 1, an electronic device 100 may include a bus 110, a processor 120, a memory 130, a user input module 140, a display module 150, or a communication module 160.

The bus 110 may be a circuit for connecting the aforementioned elements and for delivering a communication (e.g., a control message) between the aforementioned elements.

The processor 120 may receive an instruction from other elements (e.g., the memory 130, the user input module 140, the display module 150, the communication module 160, etc.), for example, via the bus 110, and thus may interpret the received instruction and execute arithmetic or data processing according to the interpreted instruction.

The memory 130 may store an instruction or data received from the processor 120 or other elements (e.g., the user input module 140, the display module 150, the communication module 160, etc.) or generated by the processor 120 or other elements. The memory 130 may include programming modules such as a kernel 131, a middleware 132, an Application Programming Interface (API) 133, an application 134, and the like. Each of the aforementioned programming modules may include software, firmware, or hardware entities or may include at least two or more combinations thereof.

The kernel 131 may control or manage the remaining other programming modules, for example, system resources (e.g., the bus 110, the processor 120, the memory 130, etc.) used to execute an operation or function implemented in the middleware 132, the API 133, or the application 134. In addition, the kernel 131 may provide a controllable or manageable interface by accessing individual elements of the electronic device 100 in the middleware 132, the API 133, or the application 134.

The middleware 132 may perform a mediation role so that the API 133 or the application 134 communicates with the kernel 131 to exchange data. In addition, regarding task requests received from the (plurality of) applications 134, the middleware 132 may perform load balancing for the task request by using a method of assigning a priority and the like capable of using a system resource (e.g., the bus 110, the processor 120, the memory 130, etc.) of the electronic device 100, for example, to at least one application among the (plurality of) applications 134.

The API 133 may include, for example, at least one interface or function for file control, window control, video processing, or character control, and the like, as an interface capable of controlling a function provided by the application 134 in the kernel 131 or the middleware 132.

The user input module 140 may receive an instruction or data, for example, from a user and deliver it to the processor 120 or the memory 130 via the bus 110. The display module 150 may display video, image, data, and the like, to the user.

The communication module 160 may connect a communication between another electronic device 102 and the electronic device 100. The communication module 160 may support a specific near-field communication protocol (e.g., Wireless Fidelity (WiFi), Bluetooth (BT), Near Field Communication (NFC), or specific network communication 162 (e.g., Internet, Local Area Network (LAN), Wide Area Network (WAN), telecommunication network, cellular network, satellite network, Plain Old Telephone Service (POTS), etc.). Each of the electronic devices 102 and 104 may be a device which is the same (e.g., the same type) as the electronic device 100 or may be a different (e.g., a different type of) device.

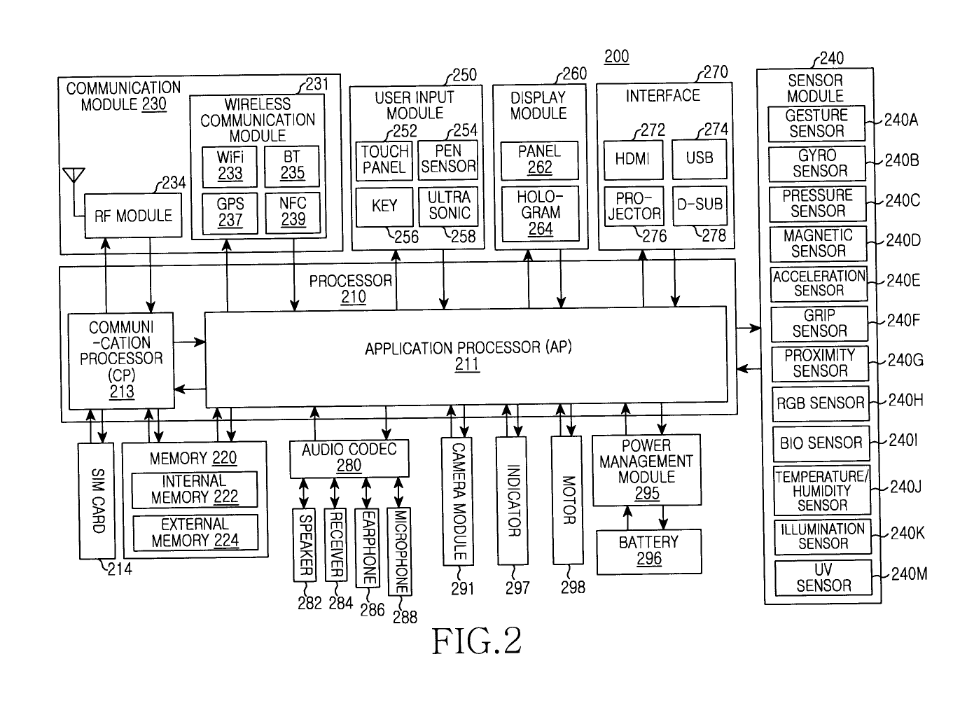

FIG. 2 is a block diagram of a hardware structure according to an example embodiment of the present disclosure. A hardware 200 may be, for example, the electronic device 100 of FIG. 1. Referring to FIG. 2, the hardware 200 may include one or more processors 210, a Subscriber Identification Module (SIM) card 214, a memory 220, a communication module 230, a sensor module 240, a user input module 250, a display module 260, an interface 270, an audio codec 280, a camera module 291, a power management module 295, a battery 296, an indicator 297, or a motor 298.

The processors 210 (e.g., the processor 120) may include one or more Application Processors (APs) 211 or one or more Communication Processors (CPs) 213. The processor 210 may be, for example, the processor 120 of FIG. 1. Although it is described in FIG. 2 that the AP 211 and the CP 213 are included in the processor 210, the AP 211 and the CP 213 may be respectively included in different Integrated Circuit (IC) packages. According to one example embodiment, the AP 211 and the CP 213 may be included in one IC package. In the present disclosure, the processor 210 may execute a payment application.

The AP 211 may control a plurality of hardware or software elements connected to the AP 211 by driving an operating system or an application program, and may perform a variety of data processing and computation including multimedia data. The AP 211 may be implemented, for example, with a System on Chip (SoC). According to one example embodiment, the processor 210 may further include a Graphic Processing Unit (GPU, not shown).

The CP 213 may perform a function of managing a data link and converting a communication protocol in a communication between different electronic devices connected with an electronic device (e.g., the electronic device 100) including the hardware 200 through a network. The CP 213 may be implemented, for example, with an SoC. According to one example embodiment, the CP 213 may perform at least a part of a multimedia control function. The CP 213 may identify and authenticate a terminal in a communication network, for example, by using a Subscriber Identification Module (SIM) (e.g., the SIM card 214). In addition, the CP 213 may provide the user with services such as voice telephony, video telephony, text messages, packet data, and the like.

In addition, the CP 213 may control data transmission/reception of the communication module 230. Although it is illustrated in FIG. 2 that the elements such as the CP 213, the power management module 295, the memory 220, and the like are separate elements independent of the AP 211, the AP 211 may be implemented to include at least a part (e.g., the CP 213) of the aforementioned elements.

According to one example embodiment, the AP 211 or the CP 213 may load an instruction or data, received from a non-volatile memory connected thereto or at least one of other elements, to a volatile memory and then may process the instruction or data. In addition, the AP 211 or the CP 213 may store data, received from the at least one of other elements or generated by the at least one of other elements, into the non-volatile memory.

The SIM card 214 may be a card in which a SIM is implemented, and may be inserted to a slot formed at a specific location of the electronic device. The SIM card 214 may include unique identification information (e.g., an Integrated Circuit Card Identifier (ICCID)) or subscriber information (e.g., an International Mobile Subscriber Identity (IMSI)).

The memory 220 may include an internal memory 222 or an external memory 224. The memory 220 may be, for example, the memory 130 of FIG. 1. The internal memory 222 may include at least one of a volatile memory (e.g., a Dynamic RAM (DRAM), a Static RAM (SRAM), a Synchronous Dynamic RAM (SDRAM), etc.) or a non-volatile memory (e.g., a One Time Programmable ROM (OTPROM), a Programmable ROM (PROM), an Erasable and Programmable ROM (EPROM), an Electrically Erasable and Programmable ROM (EEPROM), a Mask ROM, a Flash ROM, a NAND flash memory, a NOR flash memory, etc.). According to one example embodiment, the internal memory 222 may have a form of a Solid State Drive (SSD). The external memory 224 may further include, for example, Compact Flash (CF), Secure Digital (SD), Micro Secure Digital (Micro-SD), Mini Secure Digital (Mini-SD), extreme Digital (xD), memory stick, and the like.

The communication module 230 may include a wireless communication module 231 or a Radio Frequency (RF) module 234. The communication module 230 may be, for example, the communication module 160 of FIG. 1. The wireless communication module 231 may include, for example, a WiFi 233, a BlueTooth (BT) 235, a Global Positioning System (GPS) 237, or a Near Field Communication (NFC) 239. For example, the wireless communication module 231 may provide a wireless communication function by using a radio frequency. Additionally or alternatively, the wireless communication module 231 may include a network interface (e.g., a LAN card), modem, or the like for connecting the hardware 200 to a network (e.g., Internet, LAN, WAN, telecommunication network, cellular network, satellite network, POTS, etc.). In the present disclosure, the communication module 230 may request a first server to approve a payment price so that the price paid by a membership card is paid by a selected payment card. In addition, the communication module 230 may receive an instruction for executing a payment application and a first request ID from a second server. In addition, the communication module 230 may transmit a selected payment ID and a second request ID to the first server, and may transmit the selected payment ID and the second request ID to the second server.

The RF module 234 may serve to transmit/receive data, for example, an RF signal or a paged electronic signal. Although not shown, the RF module 234 may include, for example, a transceiver, a Power Amp Module (PAM), a frequency filter, a Low Noise Amplifier (LNA), and the like. In addition, the RF module 234 may further include a component (e.g., a conductor, a conducting wire, etc.) for transmitting/receiving a radio wave on a free space in a wireless communication.

The sensor module 240 may include, for example, at least one of a gesture sensor 240A, a gyro sensor 240B, a pressure sensor 240C, a magnetic sensor 240D, an acceleration sensor 240E, a grip sensor 240F, a proximity sensor 240G, a Red, Green, Blue (RGB) sensor 240H, a bio sensor 240I, a temperature/humidity sensor 240J, an illumination sensor 240K, and an Ultra Violet (UV) sensor 240M. The sensor module 240 may measure a physical quantity or detect an operation state of the electronic device, and thus may convert the measured or detected information into an electric signal. Additionally/alternatively, the sensor module 240 may include, for example, an E-node sensor (not shown), an ElectroMyoGraphy (EMG) sensor (not shown), an ElectroEncephaloGram (EEG) sensor (not shown), an ElectroCardioGram (ECG) sensor (not shown), a fingerprint sensor, and the like. The sensor module 240 may further include a control circuit for controlling at least one or more sensors included therein.

The user input module 250 may include a touch panel 252, a (digital) pen sensor 254, a key 256, or an ultrasonic input unit 258. The user input module 250 may be, for example, the user input module 140 of FIG. 1. The touch panel 252 may recognize a touch input, for example, by using at least one of an electrostatic type, a pressure-sensitive type, an infrared type, and an ultrasonic type. In addition, the touch panel 252 may further include a controller (not shown). In case of the electrostatic type, not only direct touch but also proximity recognition is also possible. The touch penal 252 may further include a tactile layer. In this case, the touch panel 252 may provide the user with a tactile reaction.

The (digital) pen sensor 254 may be implemented, for example, by using the same or similar method of receiving a user input or by using an additional sheet for recognition. The key 256 may be, for example, a keypad or a touch key. The ultrasonic input unit 258 is a device by which the terminal detects a sound wave by using a microphone (e.g., a microphone 288) through a pen which generates an ultrasonic signal, and is a device capable of radio recognition. According to one example embodiment, the hardware 200 may use the communication module 230 to receive a user input from an external device (e.g., a network, a computer, or a server) connected thereto.

The display module 260 may include a panel 262 or a hologram 264. The display module 260 may be, for example, the display module 150 of FIG. 1. The panel 262 may be, for example, a Liquid-Crystal Display (LCD), an Active-Matrix Organic Light-Emitting Diode (AM-OLED), and the like. The panel 262 may be implemented, for example, in a flexible, transparent, or wearable manner. The panel 262 may be implemented as one module with the touch panel 252. The hologram 264 may use an interference of light and show a stereoscopic image in the air. According to one example embodiment, the display module 260 may further include a control circuit for controlling the panel 262 or the hologram 264. In the present disclosure, any one of at least one payment card previously issued may be selected in the display module 260. In addition, the display module 260 may display at least one of a payment price paid by the membership card and a discount coupon price, and may receive a payment approval instruction for paying the payment price which is variable depending on the discount coupon price.

The interface 270 may include, for example, a High-Definition Multimedia Interface (HDMI) 272, a Universal Serial Bus (USB) 274, a projector 276, or a D-subminiature (D-sub) 278. Additionally or alternatively, the interface 270 may include, for example, Secure Digital (SD)/Multi-Media Card (MMC) (not shown) or Infrared Data Association (IrDA) (not shown).

The audio codec 280 may bilaterally convert a voice and electronic signal. The audio codec 280 may convert audio information which is input or output, for example, through a speaker 282, a receiver 284, an earphone 286, the microphone 288, and the like.

The camera module 291 is a device for image and video capturing, and according to one example embodiment, may include one or more image sensors (e.g., a front lens or a rear lens), an Image Signal Processor (ISP) (not shown), or a flash Light Emitting Diode (LED) (not shown).

The power management module 295 may manage power of the hardware 200. Although not shown, the power management module 295 may include, for example, a Power Management Integrated Circuit (PMIC), a charger Integrated Circuit (IC), or a battery fuel gauge.

The PMIC may be equipped, for example, inside an IC or SoC semiconductor. Charging may be classified into wired charging and wireless charging. The charger IC may charge a battery, and may avoid over-voltage or over-current flowing from a charger. According to one example embodiment, the charger IC may further include a charger IC for at least one of the wired charging and the wireless charging. The wireless charging may be classified, for example, into a magnetic resonance type, a magnetic induction type, and an electromagnetic type. An additional circuit (e.g., a coil loop, a resonant circuit, a rectifier, etc.) may be added for the wireless charging.

The battery gauge may measure, for example, a residual quantity of the battery 296 and a voltage, current, and temperature during charging. The battery 296 may generate electricity to supply power source, and may be, for example, a rechargeable battery.

The indicator 297 may indicate a specific state, e.g., a booting state, a message state, a charging state, and the like of the hardware 200 or a part thereof (e.g., the AP 211). The motor 298 may convert an electric signal into a mechanical vibration. A Micro Control Unit (MCU) may control the sensor module 240.

Although not shown, the hardware 200 may include a processing unit (e.g., a GPU) for supporting a mobile TV. The processing unit for supporting the mobile TV may process media data according to a protocol of, for example, Digital Multimedia Broadcasting (DMB), Digital Video Broadcasting (DVB), media flow, and the like.

Names of the aforementioned elements of the hardware according to various example embodiments of the present disclosure may vary depending on a type of electronic device. The hardware of the present disclosure may include at least one of the aforementioned elements. Some of the elements may be omitted, or additional other elements may be further included. In addition, some of the elements of the hardware according to various example embodiments of the present disclosure may be combined and implemented as one entity, so as to equally perform functions of corresponding elements before combination.

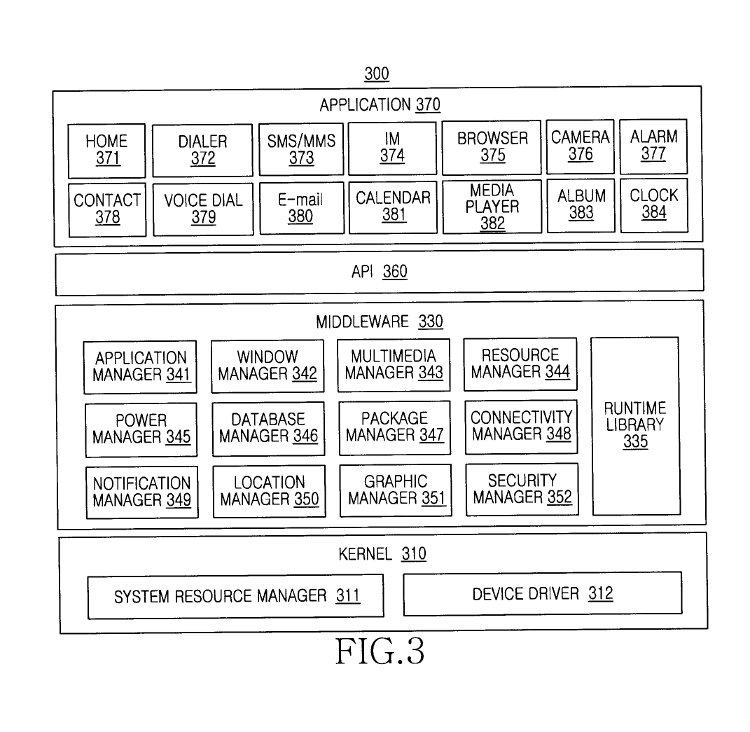

FIG. 3 is a block diagram of a programming module according to an example embodiment of the present disclosure. A programming module 300 may be included (e.g., stored) in the electronic device 100 (e.g., the memory 130) of FIG. 1. At least some parts of the programming module 300 may include software, firmware, hardware, or a combination of at least two or more of them. The programming module 300 may include an Operating System (OS) implemented in a hardware (e.g., the hardware 200) and controlling a resource related to an electronic device (e.g., the electronic device 100) or various applications (e.g., an application 370) driven on the OS. For example, the OS may be Android, iOS, Windows, Symbian, Tizen, Bada, and the like. Referring to FIG. 3, the programming module 300 may include a kernel 310, a middleware 330, an Application Programming Interface (API) 360, or the application 370.

The kernel 310 (e.g., the kernel 131) may include a system resource manager 311 or a device driver 312. The system resource manager 311 may include, for example, a process managing unit, a memory managing unit, a file system managing unit, and the like. The system resource manager 311 may perform control, allocation, retrieval, and the like of the system resource. The device driver 312 may include, for example, a display driver, camera driver, a Bluetooth driver, a shared memory driver, a USB driver, a keypad driver, a WiFi driver, or an audio driver. In addition, according to one example embodiment, the device driver 312 may include an Inter-Process Communication (IPC) driver (not shown).

The middleware 330 may include a plurality of modules pre-implemented to provide a function commonly used by the application 370. In addition, the middleware 330 may provide a function through the API 360 so that the application 370 can effectively use a limited system resource in the electronic device. For example, as shown in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module used by a compiler to add a new function through a programming language while the application 370 is executed. According to one example embodiment, the runtime library 335 may perform an operation of an input/output, a memory management, an arithmetic function, and the like.

The application manager 341 may, for example, manage a life cycle of at least one application among the applications 370. The window manager 342 may manage a Graphic User Interface (GUI) resource used in a screen. The multimedia manager 343 may recognize a format used to reproduce various media files, and may use a code suitable for the format to perform encoding or decoding of the media file. The resource manager 344 may manage a resource (e.g., a source code, a memory, a storage space, etc.) of at least any one of the applications 370.

The power manager 345 may manage a battery or power by operating together with a Basic Input/Output System (BIOS) and the like, and may provide power information and the like used for the operation. The database manager 346 may manage to generate, search, or change a database to be used in at least one application among the applications 370. The package manager 347 may manage an installation or update of an application distributed in a form of a package file.

The connectivity manager 348 may manage a wireless connection such as WiFi, Bluetooth, and the like. The notification manager 349 may display or notify an event such as an incoming message, an appointment, a proximity notification, and the like, in a manner of not disturbing the user. The location manager 350 may manage location information of the electronic device. The graphic manager 351 may manage a graphic effect to be provided to the user or a user interface related thereto. The security manager 352 may provide a general security function used for system security, user authentication, and the like. According to one example embodiment, if the electronic device (e.g., the electronic device 100) has a telephone function, the middleware 330 may further include a telephony manager (not shown) for managing a voice or video telephony function of the electronic device.

The middleware 330 may generate and use a new middleware module by combining various functions of the aforementioned internal modules. The middleware 330 may provide a module specified for each type of operating system to provide a differentiated function. In addition, the middleware 330 may dynamically delete some of the existing elements or may add new elements. Therefore, some of the elements described in the example embodiment of the present disclosure may be omitted, or other elements may be further included or may be replaced with elements having other names for performing a similar function.

The API 360 (e.g., the API 133) is a set of API programming functions, and may be provided with other configurations according to an operating system. For example, in case of Android or IOS, one API set may be provided for each platform, and in case of Tizen, two or more API sets may be provided.

The application 370 (e.g., the application 134) may include a preloaded application or a third party application. For example, the application 370 may include home application 371, dialer application 372, SMS/MMS application 373, instant massage (IM) application 374, browser application 375, camera application 376, alarm application 377, contact application 378, voice dial application 379, E-mail application 380, calendar application 381, media player application 382, album application 383, clock application 384.

At least some parts of the programming module 300 may be implemented with an instruction stored in a computer-readable storage media. If it is executed by one or more processors (e.g., the processor 210), the one or more processors may perform a function corresponding to the instruction. The computer-readable storage media may be, for example, the memory 260. At least some parts of the programming module 300 may be implemented (e.g., executed), for example, by the processor 210. At least some parts of the programming module 300 may include, for example, modules, programs, routines, sets of instructions, processes, and the like for performing one or more functions.

Names of elements of the programming module (e.g., the programming module 300) according to the present disclosure may vary depending on a type of operating system. In addition, the programming module according to the present disclosure may further include at least one or more elements among the aforementioned elements, or some of them may be omitted, or additional other elements may be further included.

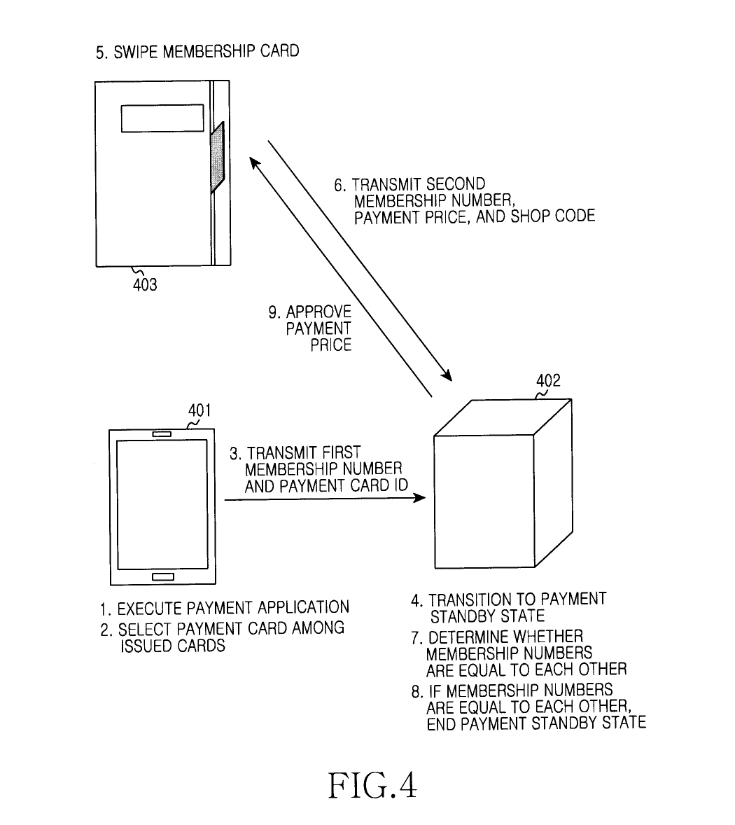

FIG. 4 illustrates an overall operation order when a membership card is used in payment according to an example embodiment of the present disclosure. An electronic device 401 according to the present disclosure is in a state in which at least one payment card and one membership card are issued. More specifically, personal information included in the payment card and the membership number assigned to the membership card are stored in a Universal Integrated Circuit Card (UICC) or an embedded Secure Element (eSE) of the electronic device 401. Hereinafter, the overall operation order when the membership card is used in payment will be described in detail according to the present disclosure.

The electronic device 401 may execute a payment application. More specifically, when an instruction for executing the payment application is input, the electronic device 401 may execute the payment application so that any one of a plurality of payment cards previously issued can be selected.

Thereafter, the electronic device 401 may display information regarding the plurality of payment cards previously issued, and thereafter any one payment card may be selected by a user selection.

Thereafter, the electronic device 401 may transmit a first membership number and a payment card ID of the selected payment card to a server 402. Herein, the first membership number is a number assigned to the membership card, which is also stored in the electronic device 401 (for identification purposes). In addition, the payment card ID may be, for example, a unique serial ID assigned to the payment card that was selected by the user selection. Thereafter, the server 402 may transition to a payment standby state.

The card terminal 403 may read the second membership number from the membership card when it is swiped in the card terminal 403. That is, the card terminal 403 may recognize the membership card and may read the membership number stored in a chip of the membership card.

Thereafter, the card terminal 403 may transmit data including the second membership number, a payment price, and shop code information to the server 402. More specifically, the card terminal 403 may transmit to the server 402 the second membership number read from the membership card, the payment price to be paid by the membership card, and the shop code information of a shop in which the card terminal 403 is located (e.g., the vendor or establishment to be paid).

Thereafter, the server 402 may determine whether the first membership number and the second membership number match. More specifically, the server 402 may map the first membership number and payment card ID received from the electronic device 401 and the payment card number stored in the server 402 to the second membership number, payment price, and shop code received from the card terminal 403. Thereafter, in order to approve the payment price, the server 402 may determine whether the first membership number matches the second membership number among the aforementioned plurality of pieces of information.

If it is determined in the server 402 that the first membership number matches the second membership number, the server 402 may terminate the payment standby state. That is, if it is determined in the server 402 that the first membership number matches the second membership number, the server 402 may terminate the payment standby state and confirm that a user of the electronic device is the same user of the membership card.

Thereafter, the server 402 may approve the payment price to the card terminal 403. The card terminal 403 may execute the payment for a product purchased by the user or a service fee, and may output a resultant receipt. Hereinafter, a detailed example embodiment will be described from a user's perspective on the basis of the aforementioned operation order.

First, after finishing a meal in a restaurant, the user executes a payment application installed in an electronic device to pay the restaurant bill, which may be, for example, 100 dollars. Thereafter, the user selects “payment card A” among payment cards previously issued, because perhaps it is suitable for the particular restaurant establishment.

Thereafter, the user hands the membership card to an employee of the restaurant (e.g., the waiter), and for payment of the 100 dollars. Thereafter, the employee swipes the membership card at a card terminal installed in the restaurant. Subsequently, after the above-described steps of matching membership numbers and approving the charge, the card terminal detects that the transaction was completed and outputs a receipt, and indicates to the employee that the payment was approved.

Thereafter, the employee of the restaurant returns the membership card and the receipt to the user, and the payment procedure is finished. As described above, the disclosure facilitates the user executing every payment utilizing only one membership card, eliminating the need to carry and a plurality of credit cards. Therefore, a user's convenience is improved, and further, the payment method is effective in an establishment in which an NFC-enabled payment is not available.

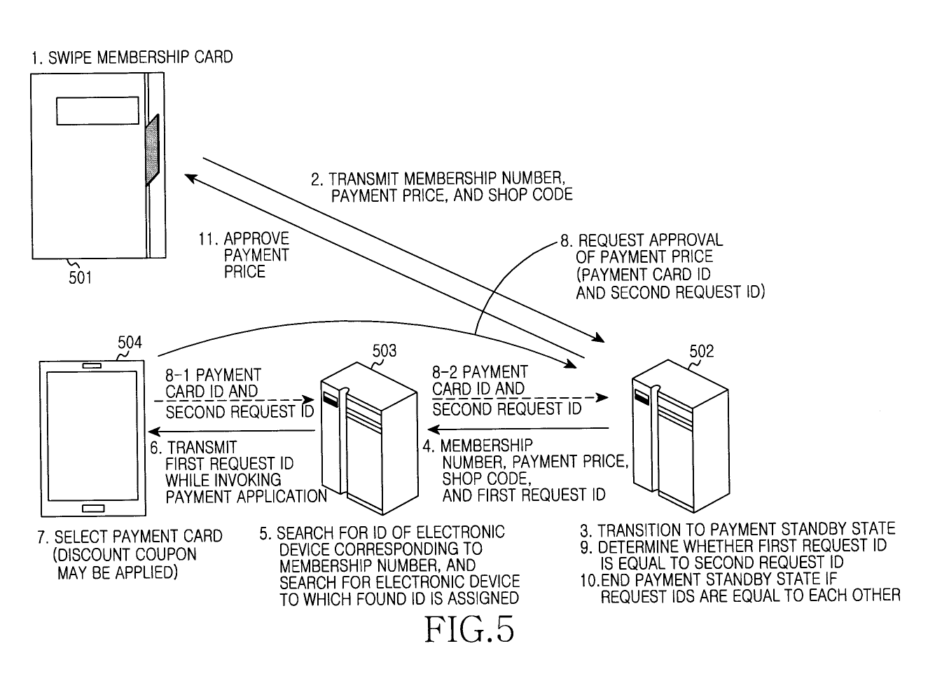

FIG. 5 illustrates an overall operation order when a membership card is used in payment according to an example embodiment of the present disclosure. An electronic device 504 may facilitate payments utilizing at least one payment card and one physical membership card. More specifically, a UICC or eSE of the electronic device 504 stores in memory personal information related to the payment card and a membership number assigned to the membership card. Hereinafter, the overall operation order when the membership card is used in payment will be described in detail according to the present disclosure.

First, when initiating a payment transaction, a membership card may be swiped at a card terminal 501, which may read a membership number from the membership card. That is, the card terminal 501 may recognize the membership card and may read the membership number stored in a chip of the membership card.

Thereafter, the card terminal 501 may transmit data including the membership number, a payment amount, and shop code information to a first server 502, which may represent a server of a card network company or a card-issuing bank More specifically, the card terminal 501 may transmit to the first server 502 the membership number read from the membership card, the payment amount to be paid with the membership card, and the shop code information that identifies the establishment in which the card terminal 501 is located.

Thereafter, the first server 502 may transition to a payment standby state. More specifically, the first server 502 may receive the data including a membership number, a payment amount, and shop code information from the card terminal 501, and initiate and maintain a payment standby state until an approval of the payment is received from the electronic device 504 or a second server 503, which may represent a server of a communication company of the electronic device 504.

Thereafter, the first server 502 may transmit a membership number, a payment amount, a shop code, and a first request ID (e.g., identifying the transaction request) to the second server 503. That is, the first server 502 may transmit to the second server 503 the membership number, payment amount, shop code, and first request ID received from the card terminal 501.

Thereafter, the second server 503 may search for an ID of an electronic device corresponding to a membership number, and may search for the electronic device to which the found ID is assigned. That is, since data regarding electronic devices corresponding to the same communication company is stored in the second server 503, it is possible to identify the electronic device corresponding to the membership number received from the first server 502.

Thereafter, the second server 503 may transmit the first request ID together with an instruction for executing a payment application to the identified electronic device 504. That is, the second server 503 may transmit to the electronic device 504 the first request ID received from the first server 502 and causing the payment application to be executed automatically in the found electronic device 504.

Thereafter, after executing the payment application, the electronic device 504 may display information regarding a plurality of payment cards previously issued, and thereafter any one payment card may be selected by a user selection. If it is confirmed in the electronic device that a discount coupon is applied, the electronic device may display at least one of a payment amount to be paid by the membership card and a discount coupon price, and thereafter may receive a payment approval instruction for paying the payment price which may have been altered because of the application of the discount coupon.

Thereafter, the electronic device 504 may request application of the payment to the first server 502. More specifically, the electronic device 504 may transmit a selected payment card ID and a second request ID (e.g., identifying the current transaction) to the first server 502, and thus may request application of the payment.

Thereafter, the first server 502 may receive a request for application of the payment from the electronic device 504 or the second server 503, and thereafter may determine whether the first request ID and the second request ID are equal to each other (e.g., to ensure that the process is being conducted for the same transaction). More specifically, the first server 502 may determine whether the first request ID transmitted by the first server 502 to the second server 503 is equal to the second request ID received from the electronic device 504 or the second server 503.

If it is determined in the first server 502 that the first request ID and the second request ID are equal to each other, the first server may end a payment standby state. That is, if it is determined in the first server 502 that the first request ID and the second request ID are equal to each other, the first server 502 may end the payment standby state by confirming that a user of the electronic device is the same user of the membership card and approving the payment.

Thereafter, the first server 502 may transmit data indicating approval of the payment price to the card terminal 501. Therefore, the card terminal 501 may end the transaction and output a resultant receipt. Hereinafter, a detailed example embodiment will be described from a user's perspective on the basis of the aforementioned operation order.

First, after finishing a meal in a restaurant, in order to pay a bill of $100 dollars, the user hands their membership card to an employee of the restaurant, and instructs the employee to charge $100 dollars for the meal on the membership card.

Thereafter, the payment application is executed automatically in the electronic device, and thereafter the user selects a “payment card A” among payment cards displayed by the electronic device.

Thereafter, the steps described above are performed approving the payment, and thus the employee of the restaurant returns the membership card and the receipt to the user, and the payment procedure is finished. As described above, the user can carry out every payment by using one membership card without having to carry several credit cards. Therefore, a user's convenience can be improved, and it can be effective in a shop in which an NFC payment is not available.

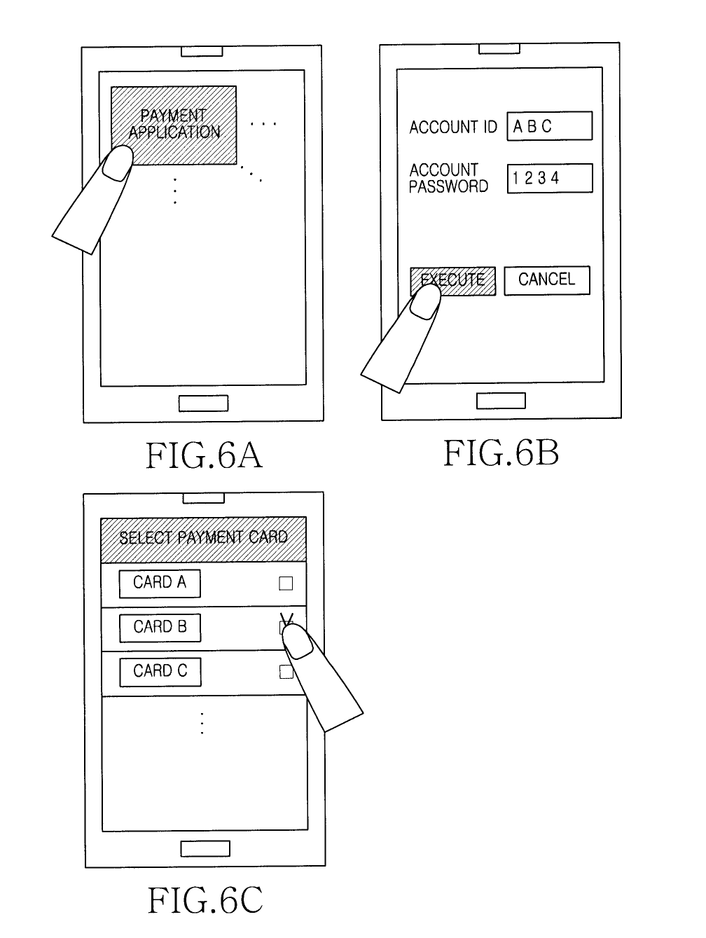

FIG. 6 illustrates an example embodiment in which a payment card is selected by executing a payment application according to the present disclosure. First, an electronic device may display icons of a plurality of applications installed in the electronic device to a display module of the electronic device. Thereafter, the electronic device may select an icon of a payment application among the plurality of application icons displayed to the display module of the electronic device. For example, as shown in FIG. 6A, the electronic device may select the payment application in which at least one payment card previously issued is stored among the plurality application icons displayed to the display module of the electronic device.

Thereafter, the electronic device may be subject to a user authentication process to execute the payment application. More specifically, to avoid an access of other users, the electronic device may be subjected to the user authentication process by using an account ID and an account password when executing the payment application. For example, as shown in FIG. 6B, when an account ID such as “ABC” and an account password such as “1234” are input, the electronic device may execute the payment application if they are equal to a pre-set account ID and a pre-set account password.

Thereafter, the electronic device may display information regarding at least one payment card previously issued, so that a user selection is input. For example, as shown in FIG. 6C, the electronic device may display a “card A”, “card B”, “card C”, and the like previously issued to the display module, and thereafter the “card C” may be selected as the payment card by the user selection.

Thereafter, the electronic device may be subjected to the user authentication process as to a payment card selected by the user. Although not shown in FIG. 6, when a password or the like of the payment card selected by the user is input, the electronic device may pay for a product paid by a membership card or a service fee.

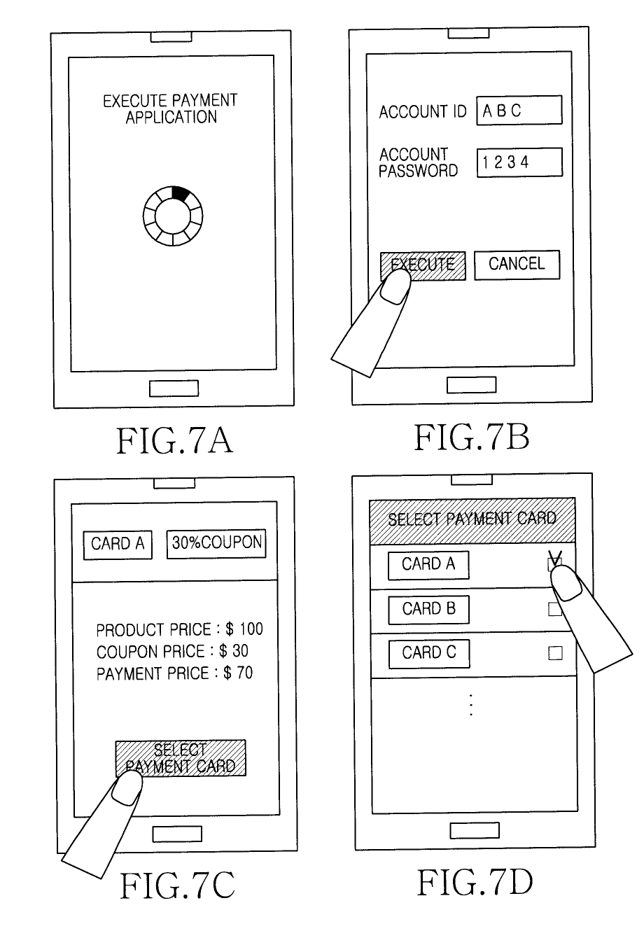

FIG. 7 illustrates an example embodiment in which a payment card is selected by executing a payment application according to the present disclosure. First, an electronic device may receive an instruction for executing the payment application from a server of a communication company, and may execute the installed payment application. For example, as shown in FIG. 7A, the electronic device may receive the instruction for executing the installed payment application from the server of the communication company, and may automatically execute the payment application.

Thereafter, the electronic device may be subject to a user authentication process to execute the payment application. More specifically, to avoid an access of other users, the electronic device may be subjected to the user authentication process by using an account ID and an account password when executing the payment application. For example, as shown in FIG. 7B, when an account ID such as “ABC” and an account password such as “1234” are input, the electronic device may execute the payment application if they are equal to a pre-set account ID and a pre-set account password.

Thereafter, the electronic device may display a product paid by a membership card or a service fee to a display module of the electronic device. Herein, if there is a product to which a discount coupon is applied, the electronic device may display a payment card to which the discount coupon is applied to the display module of the electronic device. For example, as shown in FIG. 7C, if it is paid by a “card A”, the electronic device may display 100 dollars for a price of the product paid by the membership card together with 30 dollars which is a price to which the discount coupon is applied.

Thereafter, the electronic device may display information regarding at least one payment card previously issued, so that a user selection is input. For example, as shown in FIG. 7D, the electronic device may display a “card A”, “card B”, “card C”, and the like previously issued to the display module, and thereafter may the “card A” may be selected as the payment card by the user selection.

Thereafter, the electronic device may be subjected to the user authentication process as to a payment card selected by the user. Although not shown in FIG. 7, when a password or the like of the payment card selected by the user is input, the electronic device may pay for the product paid by the membership card or the service fee.

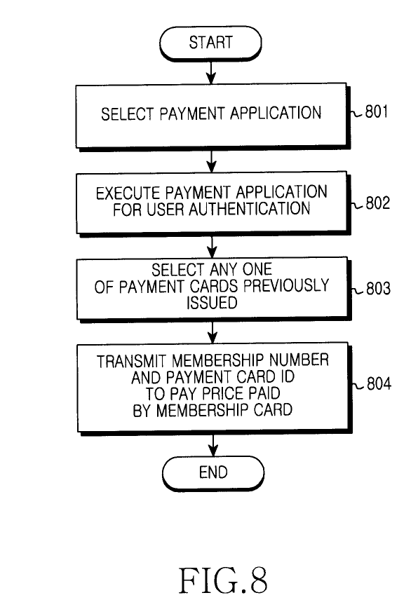

FIG. 8 is a flowchart illustrating an operation order of an electronic device according to an example embodiment of the present disclosure. First, as shown in FIG. 8, a payment application may be selected in the electronic device (step 801). More specifically, an icon of the payment application may be selected in the electronic device among a plurality of applications displayed to a display module of the electronic device.

Thereafter, the electronic device may be subjected to a user authentication by executing the payment application (step 802). More specifically, to avoid an access of other users, the electronic device may be subjected to the user authentication process by using an account ID and an account password when executing the payment application.

Thereafter, any one of payment cards previously issued may be selected in the electronic device (step 803). For example, the electronic device may display a “card A”, “card B”, “card C”, and the like previously issued to the display module, and thereafter the “B card” may be selected as the payment card by a user selection.

Thereafter, the electronic device may transmit a membership number and a payment card ID to a server to pay a price paid by a membership card (step 804). Herein, the membership number is a number stored in the electronic device as a number assigned to the membership card. In addition, the payment card ID is a unique serial ID assigned to the payment card selected by the user selection.

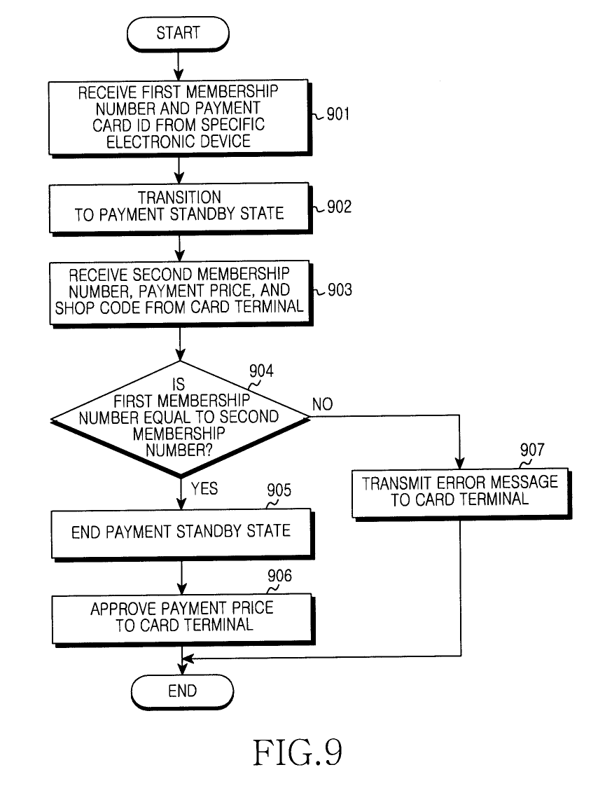

FIG. 9 is a flowchart illustrating an operation order of a server according to an example embodiment of the present disclosure. First, as shown in FIG. 9, the server may receive a first membership number and a payment card ID from a specific electronic device (step 901). Herein, the first membership number is a number stored in the electronic device as a number assigned to a membership card, and the payment card ID is a unique serial ID assigned to the payment card selected by a user selection.

Thereafter, the server may transition to a payment standby state (step 902). More specifically, the server may receive a second membership number, payment information, and the like from a card terminal, and may keep the payment standby state until it is determined that the first membership number and the second membership number are equal to each other. Herein, the server may be a server of a card network company or a server of a card issuing bank.

Thereafter, the server may receive the second membership number, a payment price, and a shop code from the card terminal (step 903). More specifically, the server may receive from the card terminal the second membership number which is read from the membership card by the card terminal, a payment price paid by the membership card, and shop code information of a shop in which the card terminal is located.

Thereafter, the server may determine whether the first membership number and the second membership number are equal to each other (step 904). More specifically, the server may map the first membership number and payment card ID received from the electronic device and the payment card number stored in the server to the second membership number, payment price, and shop code received from the card terminal. Thereafter, in order to approve the payment price, the server may determine whether the first membership number is equal to the second membership number among the aforementioned plurality of pieces of information.

If it is determined in the server that the first membership number is equal to the second membership number, the server may end the payment standby state (step 905). That is, if it is determined in the server that the first membership number is equal to the 25 second membership number, the server may end the payment standby state by confirming that a user of the electronic device is the same user of the membership card.

Thereafter, the server may approve the payment price to the card terminal (step 906). Therefore, the card terminal may end the payment for a product purchased by the user or a service fee, and may output a resultant receipt.

If it is determined in the server that the first membership number and the second membership number are not equal to each other, the server may transmit an error message to the card terminal (step 907).

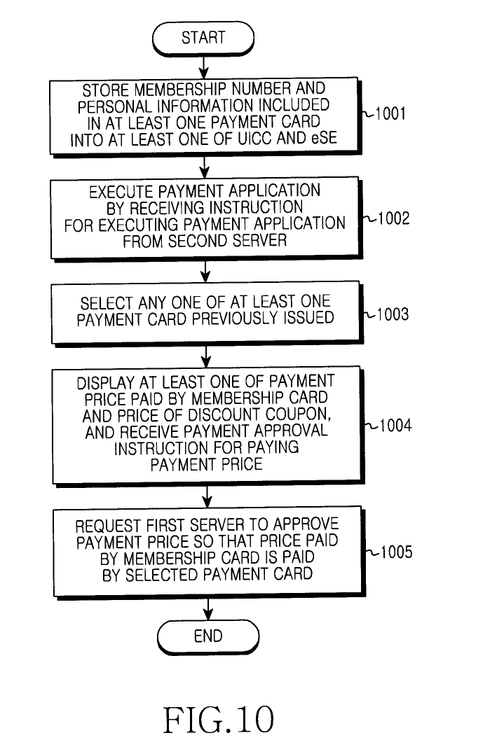

FIG. 10 is a flowchart illustrating an operation order of an electronic device according to an example embodiment of the present disclosure. First, as shown in FIG. 10, the electronic device may store a membership number and personal information included in at least one payment card into at least one of a UICC and an eSE (step 1001). More specifically, the personal information included in the payment card and the membership number assigned to a membership card may be stored in the UICC or the eSE of the electronic device.

Thereafter, the electronic device may execute a payment application by receiving an instruction for executing the payment application from a second server (step 1002). More specifically, the electronic device may automatically execute the payment application by receiving an instruction for executing the payment application from the second server.

Thereafter, any one of at least one payment card previously issued may be selected in the electronic device (step 1003). That is, the electronic device may display information regarding at least one payment card previously issued, so that a user selection is input. For example, the electronic device may display a “card A”, “card B”, “card C”, and the like previously issued to the display module, and thereafter the “card A” may be selected as the payment card by the user selection.

Thereafter, the electronic device may display at least one of a payment price paid by the membership card and a discount coupon price, and thereafter may receive a payment approval instruction for paying the payment price (step 1004). That is, if there is a product to which the discount coupon is applied, the electronic device may display a payment card to which the discount coupon is applied to the display module of the electronic device, and thus may receive the payment approval instruction for paying the payment price.

Thereafter, the electronic device may request a first server to approve the payment price so that the price paid by the membership card is paid by the selected payment card (step 1005). Herein, although the electronic device may request the first server to approve the payment price, the approval of the payment price may also be requested to the second server. In addition, when requesting the approval of the payment price, the electronic device may transmit a payment card ID and a request ID together to the first server or the second server.

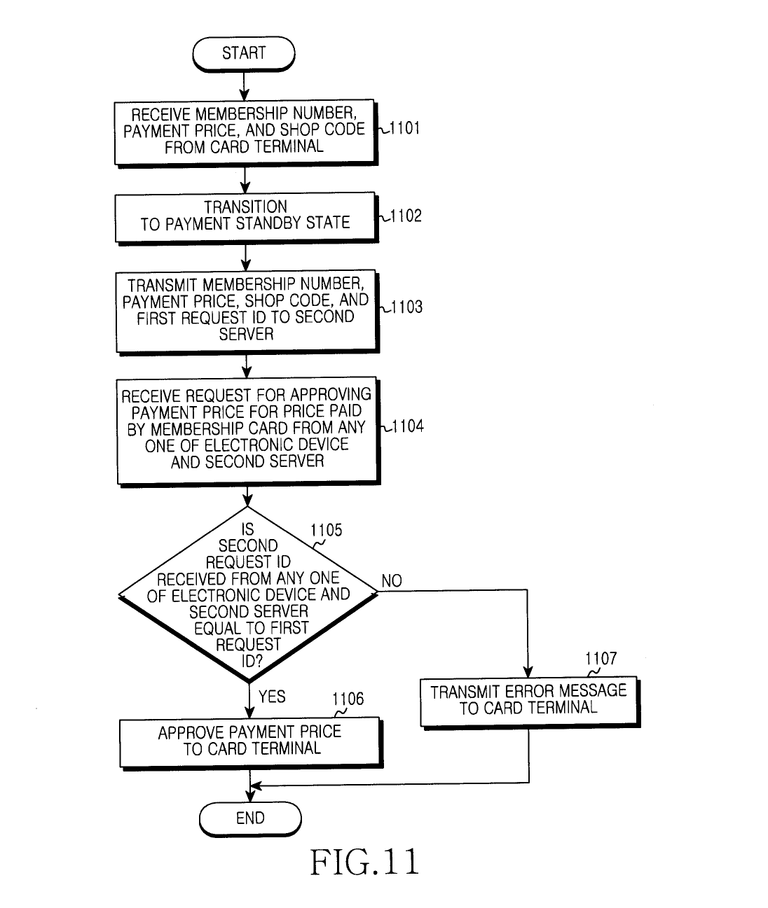

FIG. 11 is a flowchart illustrating an operation order of a first server according to an example embodiment of the present disclosure. First, as shown in FIG. 11, the first server may receive a membership number, a payment price, and a shop code from a card terminal (step 1101). More specifically, the first server may receive from the card terminal the membership number which is read from a membership card by the card terminal, a payment price paid by the membership card, and shop code information of a shop in which the card terminal is located.

Thereafter, the first server may transition to a payment standby state (step 1102). More specifically, the first server may receive data including a membership number, a payment price, and shop code information from the card terminal, and may keep the payment standby state until an approval of the payment is requested from the electronic device or a second server. Herein, the first server may be a server of a card network company or a server of a card issuing bank, and the second server may be a server of a communication company of the electronic device.

Thereafter, the first server may transmit a membership number, a payment price, a shop code, and a first request ID to the second server (step 1103). That is, the first server may transmit to the second server the membership number, payment price, shop code, and first request ID received from the card terminal.

Thereafter, the first server may receive a request for approving the payment price for the price paid by the membership card from any one of the electronic device and the second server (step 1104). That is, the first server may receive the request for approving the payment price for the price paid by the membership card, or may receive the request for the payment price from the second server.

Thereafter, the first server may determine whether a second request ID received from any one of the electronic device and the second server is equal to the first request ID (step 1105). More specifically, the first server may determine whether the first request ID transmitted by the first server to the second server is equal to the second request ID received from the electronic device or the second server.

If the first server determines that the second request ID received from any one of the electronic device and the second server is equal to the first request ID, the first server may approve the payment price to the card terminal (step 1106). More specifically, if it is determined in the first server that the first request ID and the second request ID are equal to each other, the first server may end the payment standby state by confirming that a user of the electronic device is the same user of the membership card, and thereafter may transmit data including a content of approving the payment price to the card terminal.

If the first server determines that the second request ID received from any one of the electronic device and the second server is not equal to the first request ID, the first server may transmit an error message to the card terminal (step 1107).

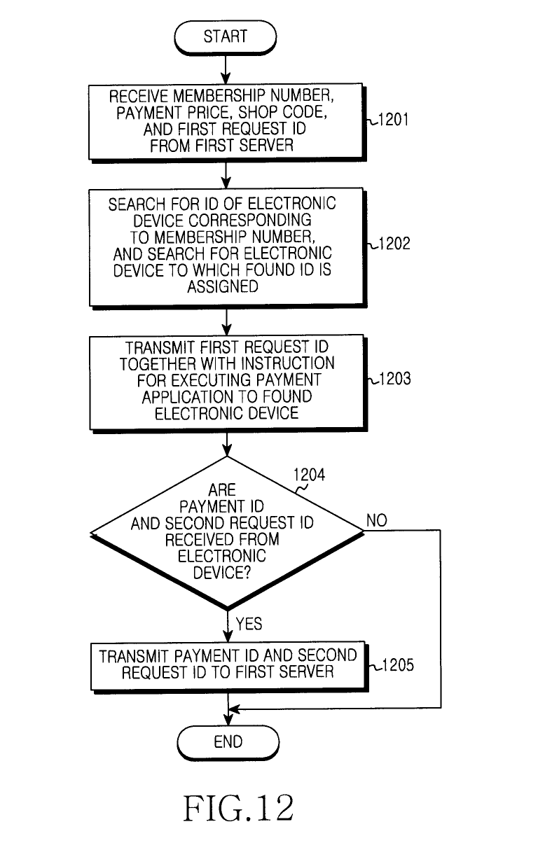

FIG. 12 is a flowchart illustrating an operation order of a second server according to an example embodiment of the present disclosure. First, as shown in FIG. 12, the second server may receive a membership number, a payment price, a shop code, and a first request ID from a first server (step 1201). That is, the second server may receive from the first server the membership number, payment price, shop code, and first request ID which are received by the first server from a card terminal.

Thereafter, the second server may search for an ID of an electronic device corresponding to a membership number, and may search for the electronic device to which the found ID is assigned (step 1202). That is, since data regarding electronic devices corresponding to the same communication company is stored in the second server, it is possible to find the electronic device corresponding to the membership number received from the first server.

Thereafter, the second server may transmit the first request ID together with an instruction for executing a payment application to the found electronic device (step 1203). That is, the second server may transmit to the electronic device the first request ID received from the first server while allowing the payment application to be executed automatically in the found electronic device.

Thereafter, the second server may determine whether the payment ID and a second request ID are received from the electronic device (step 1204).

If the second server receives the payment card ID and the second request ID from the electronic device, the second server may transmit the payment ID and the second request ID to the first server (step 1205). That is, an entity for requesting an approval of a payment price to the first server may be either the electronic device or the second server.

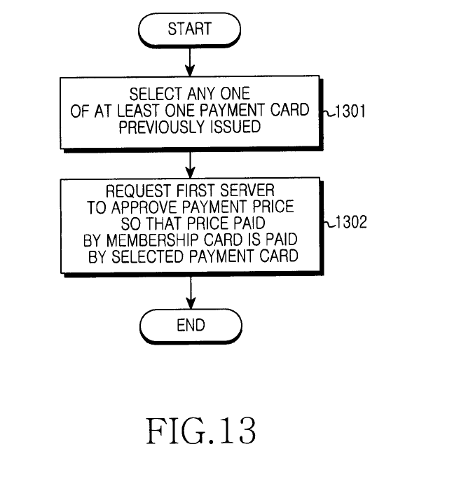

FIG. 13 is a flowchart illustrating a method of an electronic device according to the present disclosure. First, as shown in FIG. 13, any one of at least one payment card previously issued may be selected in the electronic device (step 1301). More specifically, the electronic device may store a membership number and personal information included in at least one payment card into at least one of a UICC and an eSE, and thereafter may receive an instruction for executing a payment application from a second server, so that any one of at least one payment card previously issued can be selected after the payment application is executed.

Thereafter, the electronic device may request a first server to approve a payment price so that the price paid by a membership card is paid by the selected payment card (step 1302). Herein, although the electronic device may request the first server to approve the payment price, the approval of the payment price may also be requested to the second server. In addition, when requesting the approval of the payment price, the electronic device may transmit a payment card ID and a request ID together to the first server or the second server.

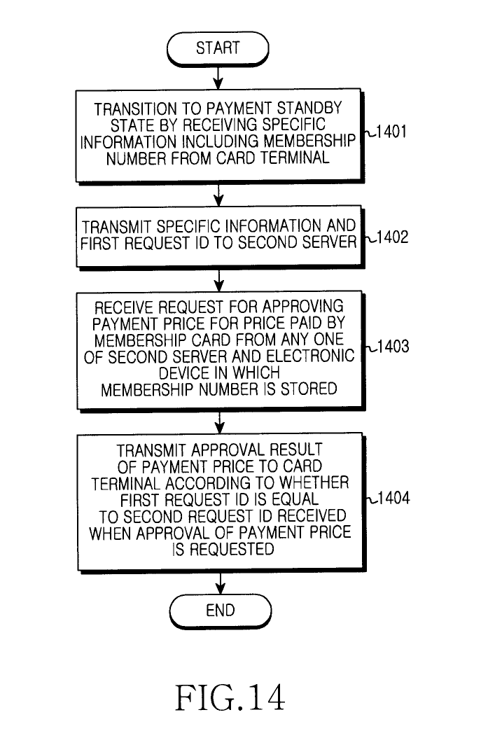

FIG. 14 is a flowchart illustrating a method of a first server according to the present disclosure. First, as shown in FIG. 14, the first server may transition to a payment standby state by receiving specific information including a membership number from a card terminal (step 1401). More specifically, the first server may receive data including a membership number a payment price, and shop code information from the card terminal, and may keep the payment standby state until an approval of the payment is requested from the electronic device or a second server. Herein, the first server may be a server of a card network company or a server of a card issuing bank, and the second server may be a server of a communication company of the electronic device.

Thereafter, the first server may transmit the specific information and a first request ID to the second server (step 1402). Herein, the specific information may be information regarding a membership number, a payment price, a shop code, and the like. That is, the first server may transmit to the second server the membership number, payment price, shop code, and first request ID received from the card terminal.

Thereafter, the first server may receive a request for approving a payment price for a price paid by a membership card from any one of the second server and the electronic device in which the membership number is stored (step 1403). That is, the first server may receive the request for approving the payment price for the price paid by the membership card, or may receive the request for the payment price from the second server.

Thereafter, the first server may transmit an approval result of the payment price to the card terminal according to whether the first request ID is equal to a second request ID received when the approval of the payment price is requested (step 1404). If the first server determines that the second request ID received from any one of the electronic device and the second server is not equal to the first request ID, the first server may approve the payment price to the card terminal. However, if the first server determines that the second request ID received from any one of the electronic device and the second server is not equal to the first request ID, the first server may transmit an error message to the card terminal.

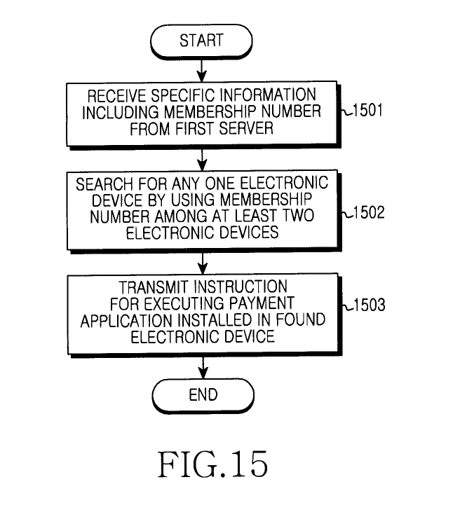

FIG. 15 is a flowchart illustrating a method of a second server according to the present disclosure. First, as shown in FIG. 15, the second server may receive specific information including a membership number from a first server (step 1501). More specifically, the second server may receive from the first server the membership number, a payment price, a shop code, and a first request ID which are received by the first server from a card terminal.

Thereafter, the second server may search for any one electronic device by using the membership number among at least two electronic devices (step 1502). That is, since data regarding electronic devices corresponding to the same communication company is stored in the second server, it is possible to find the electronic device corresponding to the membership number received from the first server.

Thereafter, the second server may transmit an instruction for executing a payment application installed in the found electronic device (step 1503). More specifically, the second server may transmit to the electronic device the first request ID received from the first server while allowing the payment application to be executed automatically in the found electronic device.

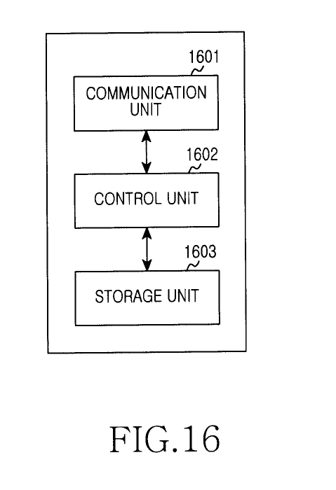

FIG. 16 is a block diagram illustrating a structure of a server according to the present disclosure. As shown in FIG. 16, the server according to the present disclosure may include a communication unit 1601, a control unit 1602, and a storage unit 1603.

First, the communication unit 1601 processes a signal transmitted and received via an antenna for voice and data communication. For example, the communication unit 1601 may transmit specific information and a first request ID to a second server, may receive a request for approving a payment price for a price paid by a membership card from any one of the second server and an electronic device in which a membership number is stored, and may transmit an approval result of the payment price to a card terminal according to whether the first request ID is equal to a second request ID received when the approval of the payment price is requested. In addition, the communication unit 1601 may receive a payment card ID and the second request ID from any one of the electronic device and the second server. In addition, the communication unit 1601 may receive specific information including the membership number from the first server, and may transmit an instruction for executing a payment application installed in the found electronic device. In addition, the communication unit 1601 may transmit to the found electronic device a request ID received from the first server together with the instruction, may receive a payment card ID and request ID from the found electronic device, and may transmit the received payment card ID and request ID to the first server.

The control unit 1602 provides an overall control to the server. For example, the control unit 1602 may transition to a payment standby state by receiving specific information including the membership number from the card terminal. In addition, the communication unit 1601 may determine whether the first request ID is equal to the second request ID, and if it is determined that the first request ID is equal to the second request ID, may end the payment standby state and may approve a payment price to the card terminal. In addition, the control unit 1602 may search for any one electronic device by using the membership number among at least two electronic devices, may search for an ID of an electronic device corresponding to the membership number received from the first server, and may search for an electronic device to which the found ID is assigned.

The storage unit 1603 may include a program storage unit which stores a program for controlling an operation of a server and a data storage unit which stores data generated while the program is executed.

In the aforementioned structure, the control unit 1602 may perform overall functions of the server. However, these functions are separately configured and illustrated in the present disclosure to describe the respective functions separately. Therefore, when the product is implemented in practice, all functions of the server may be processed by the control unit 1602 or only some of the functions of the portable terminals may be processed by the control unit 1602.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subj ect matter in compliance with 35 U.S.C. §101.

While the present disclosure has been particularly shown and described with reference to example embodiments thereof, it will be understood by those skilled in the art that various changes in form and details may be made therein without departing from the ambit of the present disclosure as defined by the appended claims.

What is claimed is:

1. A method in an electronic device, the method comprising:
displaying by a display a plurality of payment cards;
detecting by a controller selection of at least one of the plurality of payment cards; and
transmitting to a payment server a membership number and a card identifier identifying the selected at least one of the plurality of payment cards,
wherein the payment server approves a payment to the selected at least one of the plurality of payment cards when the membership number matches a second membership identifier received from a membership card that was swiped at a payment terminal.

2. The method of claim 1, wherein at least the membership number and the card identifier are stored in at least one of a Universal Integrated Circuit Card (UICC) and an embedded Secure Element (eSE).

3. The method of claim 1, further comprising:
receiving an instruction to execute a payment application and a first request identification; and
in response to the instruction, executing the payment application including the displaying by the display the plurality of payment cards.

4. The method of claim 1, further comprising:
displaying at least one of an amount of the payment and a discount amount; and
receiving a confirmation that the payment is approved.

5. The method of claim 1, wherein the payment server receives from the payment terminal an amount of the payment to be approved and the second membership identifier from the swiped membership card.

6. The method of claim 3, further comprising transmitting to the payment terminal a second request identification based on the received request identification, wherein the payment server approves the payment when the membership identifier matches the second membership identifier and the first request identification matches the second identification.

7. A method in a payment server, the method comprising:
receiving from a payment terminal a first request to process a payment including a membership number;
in response to the request, executing a payment standby state and transmitting to a terminal server specific information including the membership number, and a first request identification to identify the payment;
receiving from the terminal server a second request to process the payment and a card identifier and a second request identification, wherein the terminal server:
identifies a portable terminal based on the membership number,
receives the card identifier from the portable terminal identifying a payment card to be used for the payment from the portable terminal, and
receives a second request identification from the portable terminal generated from the first request identification; and
transmitting to the card terminal an approval of the payment when the first request identification matches the second request identification.

8. The method of claim 7, wherein the specific information further comprises at least one of an amount of the payment, and a shop code identifying an establishment corresponding to the card terminal.

9. The method of claim 7, wherein the card identifier and the second request identification are transmitted from the portable terminal to the terminal server, and from the terminal server to the payment server.

10. The method of claim 7, wherein the transmitting the approval further comprises:
determining whether the first request identification matches the second request identification; and
when the first request identification and the second request identification match, terminating the payment standby state and transmitting the approval of the payment to the card terminal.

11. A method in a terminal server, the method comprising:
receiving from a payment server specific information including a membership number of a membership card swiped at payment terminal and transmitted to the payment server;
detecting an electronic device communicatively coupled to the terminal server corresponding to the membership number; and
receiving from the detected electronic device a card identifier corresponding to a payment card; and
transmitting to the payment server a request to process a payment utilizing the payment card indicated by the card identifier.

12. The method of claim 11, wherein the specific information further comprises an amount of the payment, a shop code identifying an establishment associated with the payment terminal, and a request identification identifying the payment.

13. The method of claim 11, wherein the detecting the electronic device comprises at least one of:
detecting an electronic device corresponding to the membership number received from the payment server; and
detecting an electronic device to which the membership number is assigned.

14. The method of claim 11, further comprising:
receiving from the payment server a request identification identifying the payment;
receiving from the detected electronic device a second request identification generated from the request identification; and
transmitting the request identification and the second request identification to the payment server.

15. An electronic device comprising:
a display module;
a communication module; and
a processor configured to
displaying by the display module a plurality of payment cards,
detecting a selection of at least one of the plurality of payment cards, and
transmitting to a payment server a membership number and a card identifier identifying the selected at least one of the plurality of payment cards,
wherein the payment server approves a payment to the selected at least one of the plurality of payment cards when the membership number matches a second membership identifier received from a membership card that was swiped at a payment terminal.

16. The electronic device of claim 15, further comprising at least one of a UICC and an eSE configured to store at least the membership number and the card identifier.

17. The electronic device of claim 15, the processor further configured to:
receive an instruction to execute a payment application and a first request identification; and
in response to the instruction, execute the payment application including the displaying by the display the plurality of payment cards.

18. The electronic device of claim 15, the processor further configured to:
display at least one of an amount of the payment and a discount amount; and
receive a confirmation that the payment is approved.

19. The electronic device of claim 15, wherein the payment server receives from the payment terminal an amount of the payment to be approved and the second membership identifier from the swiped membership card.

20. The electronic device of claim 15, the processor further configured to:
transmit to the payment terminal a second request identification based on the received request identification,
wherein the payment server approves the payment when the membership identifier matches the second membership identifier and the request identification matches the second identification.

21. A payment server apparatus comprising:
a communication unit; and
a control unit configured to
receive from a payment terminal a first request to process a payment including a membership number;
in response to the request, execute a payment standby state and transmitting to a terminal server specific information including the membership number, and a first request identification to identify the payment;
receive from the terminal server a second request to process the payment and a card identifier and a second request identification, wherein the terminal server:
identifies a portable terminal based on the membership number,
receives the card identifier from the portable terminal identifying a payment card to be used for the payment from the portable terminal, and
receives a second request identification from the portable terminal generated from the first request identification; and
transmits to the card terminal an approval of the payment when the first request identification matches the second request identification.

22. The apparatus of claim 21, wherein the specific information further comprises at least one of an amount of the payment, and a shop code identifying an establishment corresponding to the card terminal.

23. The apparatus of claim 21, wherein the card identifier and the second request identification are transmitted from the portable terminal to the terminal server, and from the terminal server to the payment server.

24. The apparatus of claim 21, wherein the transmitting the approval further comprises:
determining whether the first request identification matches the second request identification; and
when the first request identification and the second request identification match, terminating the payment standby state and transmitting the approval of the payment to the card terminal.

25. A terminal server apparatus comprising:
a communication unit; and
a control unit configured to
receive from a payment server specific information including a membership number of a membership card swiped at payment terminal and transmitted to the payment server;
detect an electronic device communicatively coupled to the terminal server corresponding to the membership number; and
receive from the detected electronic device a card identifier corresponding to a payment card; and
transmit to the payment server a request to process a payment utilizing the payment card indicated by the card identifier.

26. The apparatus of claim 25, wherein the specific information further comprises an amount of the payment, a shop code identifying an establishment associated with the payment terminal, and a request identification identifying the payment.

27. The apparatus of claim 25, wherein the detecting the electronic device comprises at least one of:
detecting an electronic device corresponding to the membership number received from the payment server; and
detecting an electronic device to which the membership number is assigned.

28. The apparatus of claim 25, wherein the control unit is further configured to
receive from the payment server a request identification identifying the payment;
receive from the detected electronic device a second request identification generated from the request identification; and
transmit the request identification and the second request identification to the payment server.
